(19) United States
(12) Patent Application Publication
(10) Pub. No.: US 2004/0243608 A1
(43) Pub. Date: Dec. 2, 2004

(54) Method, apparatus, and computer product for sharing information

(75) Inventors: Taro Fujimoto, Kawasaki (JP); Jun Arima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/873,150

(22) Filed: Jun. 23, 2004

Related U.S. Application Data
(63) Continuation of application No. PCT/JP02/00468, filed on Jan. 23, 2002.

(51) Int. Cl. G06F 17/00

(52) U.S. Cl. 707/100

(57) ABSTRACT

A hypothetical sales database control unit controls a hypothetical sales database obtained by integrating plural databases such as a sales information database and a budget information database. A sales promotion concept control unit obtains concept information from the hypothetical sales database. An account executive view control unit displays the concept information obtained from the sales promotion concept control unit based on the concept information selected by the user from among the concept information related to a concept presented to the user.

### TECHNICAL FIELD

The present invention relates to a method, an apparatus, and a computer product that enable information sharing through the Internet and/or the intranet.

### BACKGROUND ART

Conventionally, the user can access information of interest through portal sites on the Internet and/or the intranet. The information sources were databases and the like and are managed separately by management units such as departments or companies.

However, when many databases that are managed by different management units are to be put to a common use by linking them, their user-friendliness becomes questionable since the information available gets restricted.

### DISCLOSURE OF THE INVENTION

It is an object of the present invention to solve at least the problems in the conventional technology.

An information sharing apparatus according to an aspect of the present invention includes a hypothetical database control unit that controls a hypothetical database obtained by integrating plural databases; a concept control unit that controls concept information related to a concept and obtains the concept information from the hypothetical database; and a browsing unit that presents for browsing the concept information obtained by the concept control unit based on user selection of the concept information related to the concept.

In the above information sharing apparatus, the hypothetical database control unit, the concept control unit, and the browsing unit may be provided in plurality.

An information sharing method according to another aspect of the present invention includes controlling a hypothetical database obtained by integrating plural databases; controlling concept information related to a concept and obtaining the concept information from the hypothetical database; and browsing the concept information obtained based on user selection of the concept information related to the concept.

A computer program according to still another aspect of the present invention includes instructions which when executed on a computer causes the computer to execute the above information sharing method according to the present invention.

A computer-readable recording medium according to still another aspect of the present invention stores the computer program according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an embodiment of the present invention; FIG. 2 is an example of contents of a sales information database 10, shown in FIG. 1; FIG. 3 is an example of contents of a budget information database 10₂ shown in FIG. 1; FIG. 4 is an example of contents of a development management information database 10₃ shown in FIG. 1; FIG. 5 is an example of contents of a hypothetical sales database definition file 31₁ shown in FIG. 1, FIG. 6 is an example of contents of a sales promotion concept definition file 51₁ shown in FIG. 1; FIG. 7 is an example of a view screen 90; FIG. 8 is an example of a view customization screen 100; FIG. 9 is a flow chart for explaining the process procedure according to the embodiment; and FIG. 10 is a block diagram of a computer that realizes the method according to the embodiment.

### BEST MODE FOR CARRYING OUT THE INVENTION

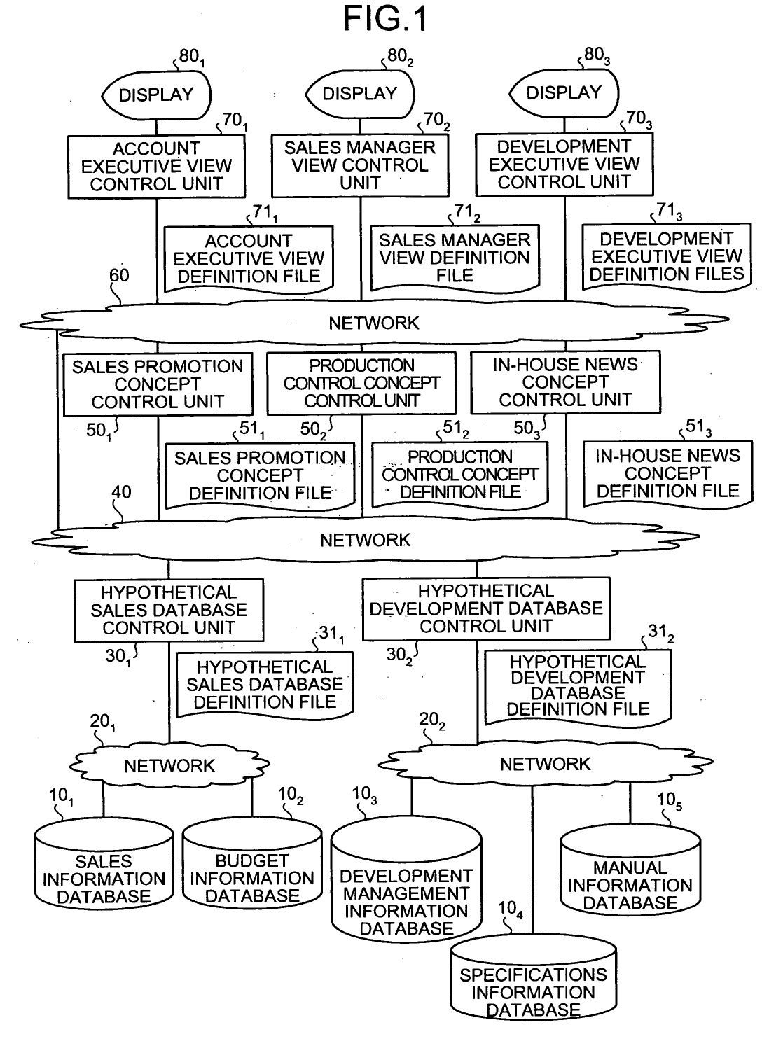

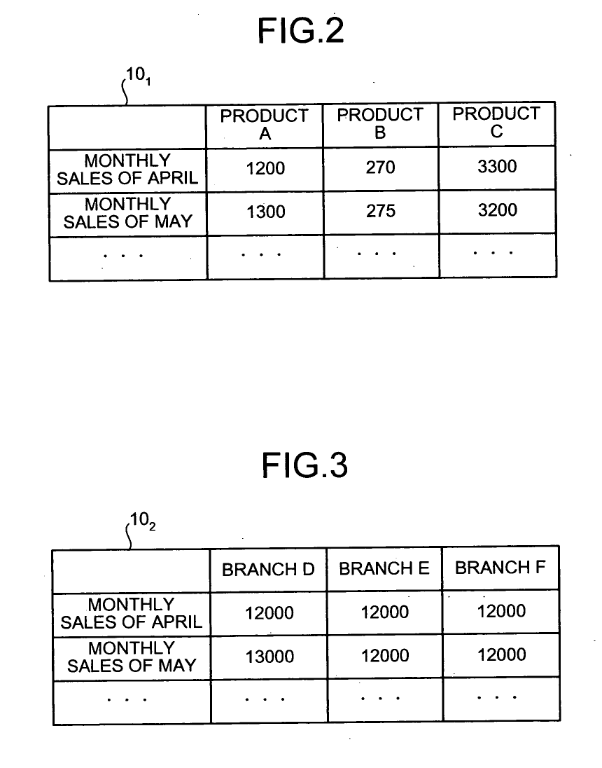

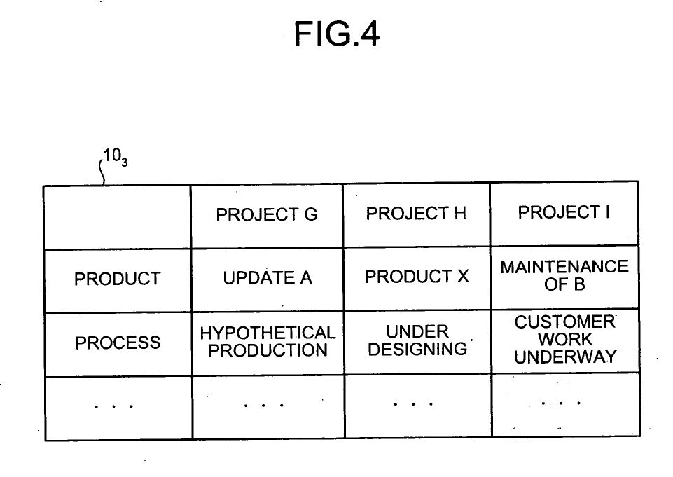

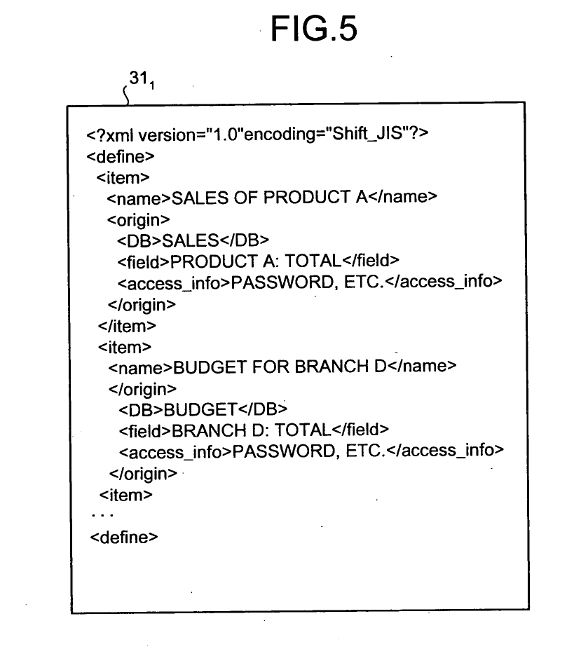

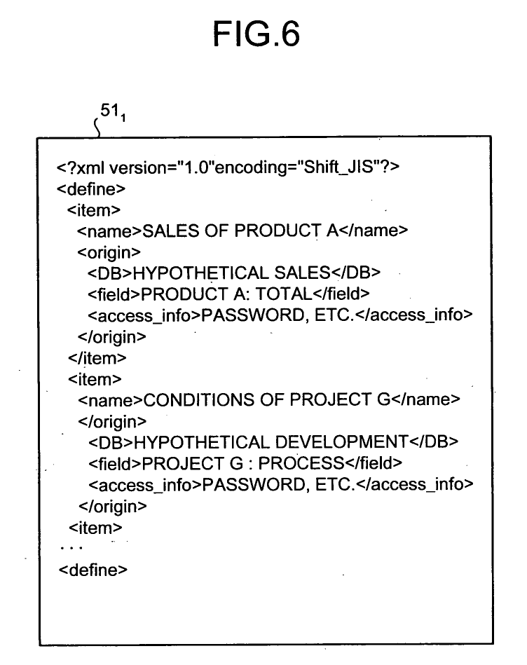

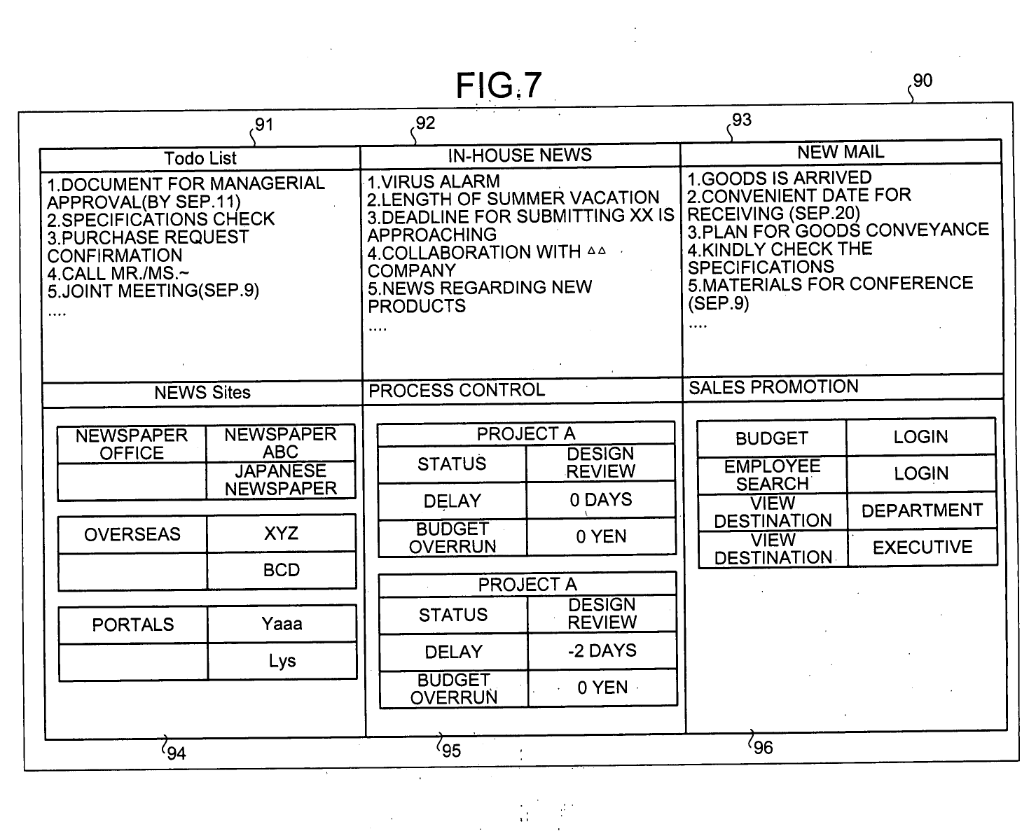

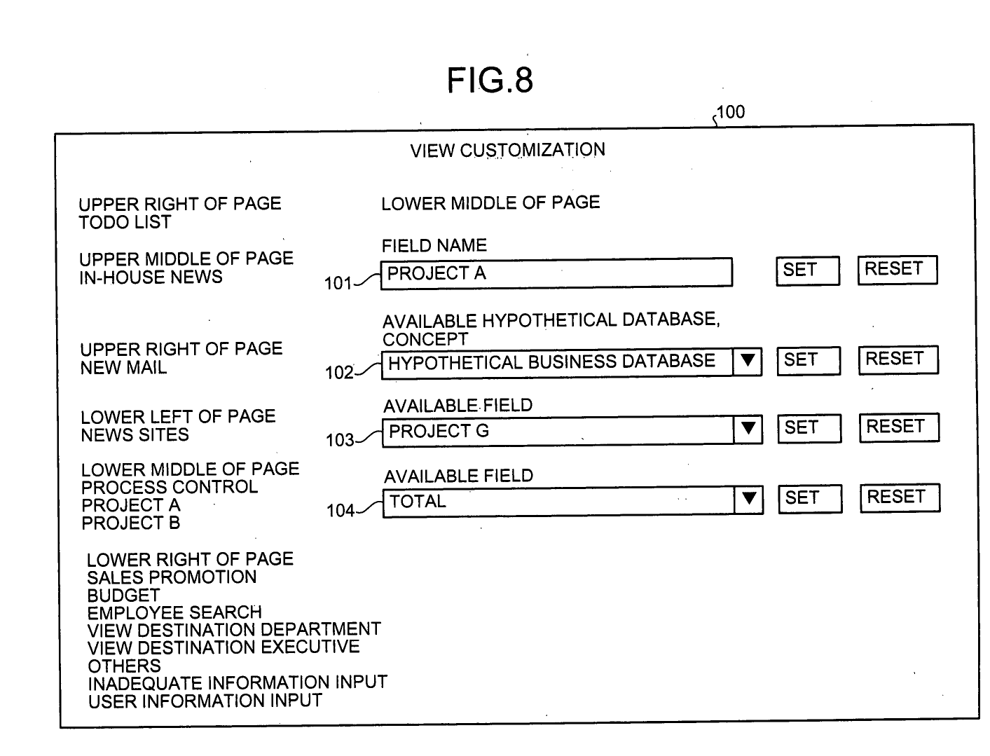

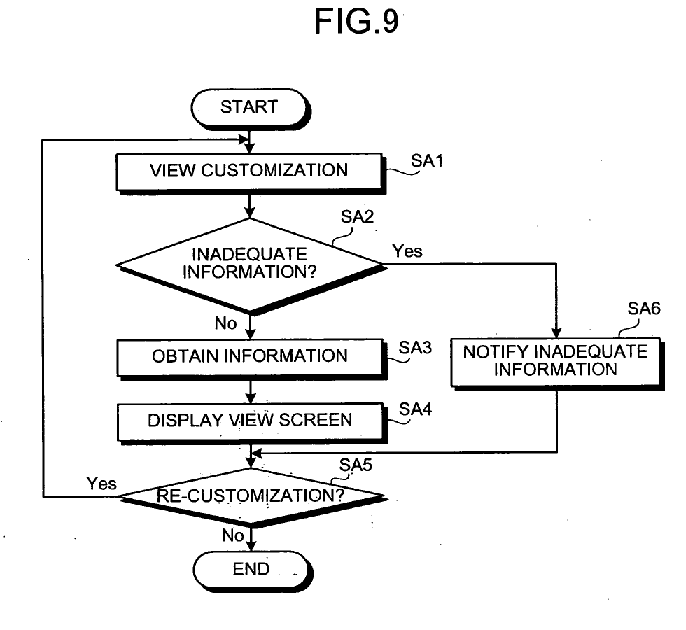

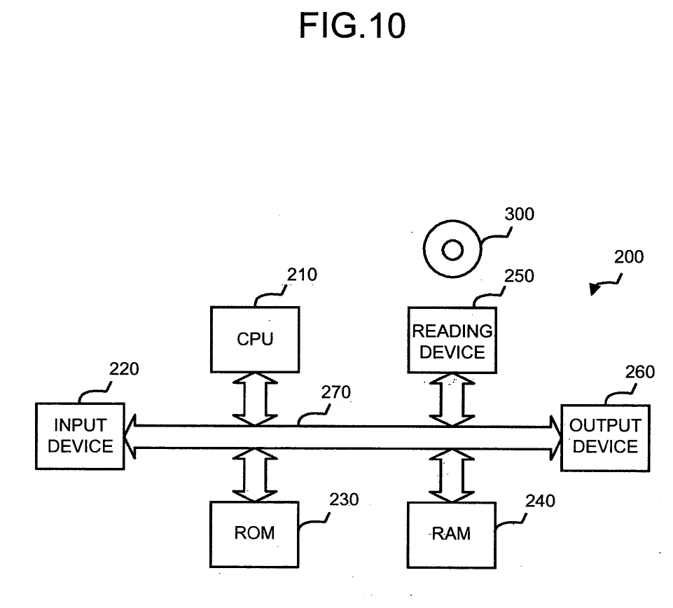

Exemplary embodiments of the present invention are explained next with reference to the accompanying drawings. FIG. 1 is a block diagram of an embodiment of the present invention. In FIG. 1, a sales information database 10₁ and a budget information database 10₂, which are databases managed by a management unit (such as sales department), can be accessed via a network 20₁.

The sales information database 10₁ stores, as shown in FIG. 2, sales information (product name and month) pertaining to product-wise monthly sales. The budget information database 10₂ stores, as shown in FIG. 3, budget information pertaining to branch-wise monthly budget.

A development management information database 10₃, a specifications information database 10₄, a manual information database 10₅, which are databases managed by another management unit (such as development department), can be accessed by another network 20₂. The development management information database 10₃ stores, as shown in FIG. 4, development management information pertaining to project-wise progress.

The specifications information database 10₄ stores information pertaining to specifications of products. The manual information database 10₅ stores information pertaining to manuals of products.

A hypothetical sales database control unit 30₁ controls a hypothetical database (hereinafter “hypothetical sales database”) related to sales obtained by integrating plural databases that relate to sales, such as the sales database 10₁ and the budget information database 10₂.

To be more specific, the hypothetical sales database control unit 30₁ controls databases based on a hypothetical sales database definition file 31₁, as shown in FIG. 5.

The hypothetical sales database definition file 31₁ is written in XML (extensible Markup Language) in which information that is to be preserved in the hypothetical sales database is defined. The information includes type (<name>Sales of product A</name>, etc.), original database (<DB>sales</DB>:sales information database 10₁, etc.), field of the original database (<field>Product A: Total</field>, etc.), access information (<access_info>Password</access_info>, etc.).

A hypothetical development database control unit 30₂ controls a hypothetical database (hereinafter “hypothetical development database”) related to development obtained by integrating plural databases that relate to development, such as the development management information database 10₃, the specifications information database 10₄, and the manual information database 10₅.

To be more specific, the hypothetical development database control unit 30₂ controls the hypothetical development database based on a hypothetical development database definition file 31₂. The hypothetical development database definition file 31₂, like the hypothetical sales database definition file 31₁, is also written in XML (see FIG. 5).

The hypothetical sales database control unit 30₁ and the hypothetical development database control unit 30₂ are connected to a network 40.

A sales promotion concept control unit 50₁ obtains, based on a sales promotion concept definition file 51₁ shown in FIG. 6, concept information related to a concept called sales promotion (hereinafter, “sales promotion concept”) from the hypothetical databases (the hypothetical sales database and hypothetical development database).

The sales promotion concept definition file 51₁ is written in XML in which information that is to be obtained from the hypothetical database is defined. The information includes type (<name>sale of product A</name>, etc.), hypothetical database from which concept information is to be obtained (<DB>hypothetical sales</DB>:hypothetical sales database, etc.), field of the hypothetical database (<field>Product A total</field>, access information (<access_info>password, etc.</access_info>, etc.).

A production control concept control unit 50₂ obtains, based on a production control concept definition file 51₂, concept information related to a concept called production control (hereinafter, “production control concept”) from the hypothetical databases (the hypothetical sales database and hypothetical development database).

The production control concept definition file 51₂, like the sales promotion concept file 51₁ (see FIG. 6), is also written in XML, and is a file in which information to be obtained from the hypothetical database, such as, type, hypothetical database from which concept information is to be obtained, hypothetical database field, access information, is defined.

An in-house news concept control unit 50₃ obtains, based on an in-house news concept definition file 51₃, concept information related to a concept called in-house news (hereinafter, “in-house news concept”) from the hypothetical databases (the hypothetical sales database and hypothetical development database).

The in-house news concept definition file 51₃, like the sales promotion concept definition file 51₁ (see FIG. 6), is written in XML, and is a file in which information to be obtained from the hypothetical database, such as, type, hypothetical database from which concept information is to be obtained, hypothetical database field, access information, is defined.

The sales promotion concept control unit 50₁, the production control concept control unit 50₂, and the in-house news concept control unit 50₃ are connected to the networks 40 and 60.

An account executive view control unit 70₁ manages, based on an account executive view definition file 71₁ information to be displayed on a view screen 90 (see FIG. 7) that is browsed by an account executive. The view screen 90 is split into six fields 91 through 96 and is displayed on a display 80₁ for browsing by the account executive.

The information displayed on the view screen 90 is defined in the account executive view definition file 71₁, and may be concept information from the sales promotion concept control unit 50₁, the production control concept control unit 50₂, and the in-house news concept control unit 50₃, or information from the hypothetical sales database or the hypothetical development database, or information from a not shown internet site, or a mail server.

Field 91 of the view screen 90 displays a Todo List of the account executive. Field 92 displays in-house news concept information from the in-house news concept control unit 50₃. Field 93 displays new mail information from the mail server (not shown).

Field 94 displays information pertaining to news sites on the Internet (not shown). Field 95 shows production control concept information from the production control concept control unit 50₂.

Field 96 displays sales promotion concept information from the sales promotion concept control unit 50₁. In an embodiment of the present invention, information from the hypothetical sales database or hypothetical development database can be displayed on any of the fields 91 through 96.

The account executive view control unit 70₁ displays on the display 80₁ a view customization screen 100 shown in FIG. 8, and enables the account executive (the user) to customize the contents of the fields 91 through 96 of the view screen 90.

A field name input field 101 of the view customization screen 100 is a field in which the user (in this case, the account executive) enters the name of any of the fields 91 through 96 (see FIG. 7).

A hypothetical database, concept selection field 102 is a field in which the user selects an available concept (sales promotion concept, production control concept, and in-house news concept) or an available hypothetical database (hypothetical sales database and hypothetical development database).

A field selection field 103 is a field in which the user selects an available field in the database or the concept selected in the hypothetical database selection field 102. A record selection field 104 is a field in which the user selects an available record in the field selected in the field selection field 103.

The user sequentially defines on the view customization screen 100 the information to be displayed in the fields 91 through 96. The information defined on the view customization screen 100 is managed as the account executive view definition file 71₁ by the account executive view control unit 70₁.

Once information has been obtained by the sales promotion concept control unit 50₁, etc., the account executive view control unit 70₁ displays, based on the account executive view definition file 71₁, the view screen 90 (see FIG. 7) on the display 80₁.

A sales manager view control unit 70₂ controls, based on a sales manager view definition file 71₂, information to be displayed on a view screen (not shown) that is browsed by a sales manager. The view screen (not shown), like the view screen 90 (see FIG. 7) is split into six fields, and is displayed on a display 80₂ for browsing by the sales manager.

The information displayed on the view screen (not shown) is defined in the sales manager view definition file 71₂, and may be concept information from the sales promotion concept control unit 50₁, the production control concept control unit 50₂, and the in-house news concept control unit 50₃, or information from the hypothetical sales database or the hypothetical development database, or information from a not shown internet site, or mail server.

The sales manager view control unit 70₂, like the account executive view control unit 70₁, displays the view customization screen 100 shown in FIG. 8 on the display 80₂, and enables the sales manager to customize the contents of the fields of the view screen.

The user (in this case, the sales manager) sequentially defines on the view customization screen 100 the information to be displayed in the fields of the view screen. The information defined on the view customization screen 100 is managed as the sales manager view definition file 71₂ by the sales manager view control unit 70₂.

Once information has been obtained by the sales promotion concept control unit 50₁, etc., the sales manager view control unit 70₂ displays, based on the sales manager view definition file 71₂, the view screen (not shown) on the display 80₂.

A development executive view control unit 70₃ controls, based on a development executive view definition file 71₃, information to be displayed on a view screen (not shown) that is browsed by a development executive. The view screen (not shown), like the view screen 90 (see FIG. 7) is split into six fields, and is displayed on a display 80₃ for browsing by the development executive.

The information displayed on the view screen (not shown) is defined in the development executive view definition file 71₃ and may be concept information from the sales promotion concept control unit 50₁, the production control concept control unit 50₂, and the in-house news concept control unit 50₃, or information from the hypothetical sales database or the hypothetical development database, or information from a not shown internet site, or mail server.

The development executive view control unit 70₃, like the account executive view control unit 70₁, displays the view customization screen 100 shown in FIG. 8 on the display 80₃, and enables the development executive to customize the contents of the fields of the view screen.

The user (in this case, the development executive) sequentially defines on the view customization screen 100 the information to be displayed in the fields of the view screen. The information defined on the view customization screen 100 is managed as the development executive view definition file 71₃ by the development executive view control unit 70₃.

Once information has been obtained by the sales promotion concept control unit 50₁, etc., the development executive view control unit 70₃ displays, based on the development executive view definition file 71₃, the view screen (not shown) on the display 80₃. The networks 20₁, 20₂, 40, and 60 may be the Internet or the intranet.

FIG. 9 is a flow chart that explains how an embodiment of the present invention works. In Step SA1 the account executive view control unit 70₁ carries out view customization.

To be more specific, the account executive view control unit 70₁ displays on the display 80₁ the view customization screen 100 shown in FIG. 8, enabling the user (in this case, the account executive) to customize it. The account executive view control unit 70₁ then treats the information on the customization screen as the account executive view definition file 71₁.

In Step SA2, the account executive view control unit 70₁ assesses whether the information defined in the account executive view definition file 71₁ is inadequate. This assessment is done to check whether the information can be obtained. If the result of this assessment is ‘Yes’, in Step SA6, the account executive view control unit 70₁ notifies the account executive through e-mail that the information is inadequate.

In this way, the account executive view control unit 70₁ enhances the view screen by prompting the account executive to furnish necessary information and storing the furnished information in the database (sales information database 10₁, hypothetical sales database, etc.).

If the result of the assessment in Step SA2 is ‘No’, in Step SA3 the account executive view control unit 70₁ obtains, based on the account executive view definition file 71₁, information from the sales promotion concept control unit 50₁, the production control concept control unit 50₂, and the in-house news concept control unit 50₃, the hypothetical sales database, the hypothetical development database, etc.

In Step SA4, the account executive view control unit 70₁ displays, based on the information obtained, the view screen 90 (see FIG. 7) on the display 80₁. In Step SA5, the account executive view control unit 70₁ assesses whether there is a request for re-customization of the view screen 90, an if the result of the assessment is ‘Yes’ returns to Step SA1.

If the result of the assessment in Step SA5 is ‘No’, the process of the account executive view control unit 70₁ ends there.

A process similar to the one carried out by the account executive view control unit 70₁ (see FIG. 9) is carried out independently by the sales manager view control unit 70₂ and the development executive view control unit 70₃. Therefore, each of the view screens for the respective users (the account executive, sales manager, and development executive) is customized uniquely.

According to another embodiment, even if the sales information database 10, and the budget information database 10₂ are controlled by different management units, an integrated hypothetical sales database may be built by the, hypothetical sales database control unit 30₁.

According to yet another embodiment, a single hypothetical sales database (for instance, hypothetical sales database control unit 30₁) and a single concept control unit (for instance, sales promotion concept control unit 50₁) may be provided, and a single concept control unit may serve the purpose of plural view control units (the account executive view control unit 70₁, the sales manager view control unit 70₂, and the development executive view control unit 70₃).

According to yet another embodiment, even if the view control unit (for instance, the account executive view control unit 70₁) restrictively displays on the view screen 90 only the concept information from the concept control unit (for instance, the sales promotion concept control unit 50₁), the view control unit may be made to display information obtained directly from the hypothetical database (for instance, the hypothetical sales database control unit 30₁) along with the concept information.

According to yet another embodiment, a single concept control unit (for instance, the sales promotion concept control unit 50₁) may be provided, and plural users (view control units: for instance account executive view control unit 70₁) may share the concept control unit. In this instance, each user may respectively customize the view screen by means of the view customization screen 100 (see FIG. 8).

To sum up, according to an embodiment of the present invention, plural databases (sales information database 10₁, budget information database 10₂, and development management information database 10₃ through manual information database 10₅) control plural hypothetical databases (hypothetical sales database and hypothetical development database, respectively). Concept information related to a concept is presented to the user for selection. The concept information selected by each user is obtained from the hypothetical database and is displayed respectively on the account executive view control unit 70₁ through development executive view control unit 70₃ for browsing by the respective user. Consequently, even if the databases have different management units, information sharing can be carried out efficiently, thereby enhancing user-friendliness.

A computer program for realizing the functions described above may be recorded on a computer-readable recording medium 300 shown in FIG. 10, and the functions of the program may be realized by making a computer 200 read the program recorded on the recording medium 300.

The computer 200 comprises a CPU (Central Processing Unit) 210 that executes the program, an input device 220 such as a keyboard, mouse, and the like, a ROM (Read Only Memory) 230 that stores various data, a RAM (Random Access Memory) 240 that stores calculation parameters, etc., a reading device 250 that reads the program from the recording medium 300, an output device 260 such as a printer, and the like, and a bus 270 that connects all the devices.

The CPU 210 reads, by means of the reading device 250, the program recorded on the recording medium 300, and realizes the functions described above by executing the program. The recording medium 300 may be an optical disk, flexible disk, hard disk, etc.

To sum up, according to the present invention, a hypothetical database is obtained by integrating plural databases. Concept information related to a concept is presented to the user for selection. The concept selected by each user is obtained from the hypothetical database and is displayed for browsing by the respective user. Consequently, even if the databases are controlled by different management units, information sharing can be carried out efficiently, thereby enhancing user-friendliness.

Moreover, plural databases respectively control plural hypothetical databases. Concept information related to a concept is presented to the user for selection. The concept information selected by each user is obtained from the hypothetical database and is displayed for browsing by the respective user. Consequently, even if the databases are controlled by different management units, information sharing can be carried out efficiently, thereby enhancing user-friendliness.

Furthermore, apart from the concept information, database information is also directly obtained from the hypothetical database, and both the concept information and the database information are displayed for browsing. Consequently, user-friendliness is enhanced to the extent of display of the database information.

Moreover, a hypothetical database is obtained by integrating plural databases. Concept information related to a concept is presented to the user for selection. The concept information selected by each user is obtained from the hypothetical database and is displayed for browsing by the respective user. Consequently, even if the databases are controlled by different management units, information sharing can be carried out efficiently, thereby enhancing user-friendliness.

Furthermore, a hypothetical database is obtained by integrating plural databases. Concept information related to a concept and obtained by plural concept control units is presented to the user for selection. The concept information selected by each user is obtained from the hypothetical database and is displayed for browsing by the respective user. Consequently, even if the databases are controlled by different management units, information sharing can be carried out efficiently, thereby enhancing user-friendliness.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

Industrial Applicability

The information sharing apparatus, the information sharing method, and the information sharing program according to the present invention are suitable for sharing information that are managed by different management units such as different departments of a company, or different companies, and the like.

1. An information sharing apparatus, comprising:
a hypothetical database control unit that controls a hypothetical database obtained by integrating plural databases;
a concept control unit that controls concept information related to a concept and obtains the concept information from the hypothetical database; and
a browsing unit that presents for browsing the concept information obtained by the concept control unit based on user selection of the concept information related to the concept.

2. The information sharing apparatus according to claim 1, wherein
a plurality of hypothetical database control units are provided each hypothetical database control unit controls a corresponding hypothetical database obtained by integrating a plurality of databases;
a plurality of the concept control unit are provided, each concept control unit controls a corresponding concept information related to a corresponding concept, and each concept control unit obtains the corresponding concept information from the corresponding hypothetical database; and
a plurality of the browsing units are provided, one browsing unit for each user, and the browsing units share the concept control units.

3. The information sharing apparatus according to claim 2, wherein the browsing units obtain, based on user selection, database information excluding the concept information, and present for browsing the database information along with the concept information obtained by the concept control units.

4. The information sharing apparatus according to claim 1, wherein a plurality of the browsing units are provided, one browsing unit for each user, and the browsing units share the concept control unit.

5. The information sharing apparatus according to claim 1, wherein
a plurality of the concept control unit are provided, each concept control unit controls a corresponding concept information related to a corresponding concept, and each concept control unit obtains the corresponding concept information from the hypothetical database; and
a plurality of the browsing units are provided, one browsing unit for each user, and the browsing units share the concept control unit.

6. An information sharing method, comprising:
controlling a hypothetical database obtained by integrating plural databases;
controlling concept information related to a concept and obtaining the concept information from the hypothetical database; and
browsing the concept information obtained based on user selection of the concept information related to the concept.

7. A computer program that includes instructions which when executed on a computer causes the computer to execute:
controlling a hypothetical database obtained by integrating plural databases;
controlling concept information related to a concept and obtaining the concept information from the hypothetical database; and
browsing the concept information obtained based on user selection of the concept information related to the concept.

8. A computer-readable recording medium that stores a computer program that includes instructions which when executed on a computer causes the computer to execute:
controlling a hypothetical database obtained by integrating plural databases;
controlling concept information related to a concept and obtaining the concept information from the hypothetical database; and
browsing the concept information obtained based on user selection of the concept information related to the concept.
